(19) United States
(12) Patent Application Publication
(10) Pub. No.: US 2005/0000487 A1
(43) Pub. Date: Jan. 6, 2005

(54) Fuel-air mixing structure and method for internal combustion engine

(76) Inventors: Roger R. Baalke, Bowling Green, KY (US); David W. Rawls, Johnson City, TN (US)

Correspondence Address: Donald W. Spurrell, P.O. Box 970, Johnson City, TN, 37605, US

(21) Appl. No.: 10/837,856

(22) Filed: May 3, 2004

Related U.S. Application Data
(60) Provisional application No. 60/467,475, filed on May 1, 2003.

(51) Int. Cl. F02B 31/04

(52) U.S. Cl. 123/306

(57) ABSTRACT

The structure and method of controlling engine fuel-air mixing for internal combustion engine applications, comprising utilizing a fuel injection module and incorporating therein a plurality of aerodynamically shaped vanes which impart vorticities to the incoming air in directions and durations to cause intimate mixing of the fuel and air. This module is readily structurally adaptable for mounting in the air intake system of practically any internal combustion engine.

### BACKGROUND OF THE INVENTION

This application claims priority under 35 U.S.C. 119(e)(1) based on Applicant's Provisional U.S. patent application Ser. No. 60/467,475, filed May 1, 2003 and titled “FUEL-AIR MIXING STRUCTURE AND METHOD FOR INTERNAL COMBUSTION ENGINES”.

### FIELD

This invention concerns improvements in the air intake systems of internal combustion engines and more particularly to a unique means for achieving more intimate mixing of the air with injected fuel.

### SUMMARY OF THE INVENTION

The structure and method of controlling engine fuel-air mixing for internal combustion engine applications, comprising utilizing a fuel injection module and incorporating therein a plurality of aerodynamically shaped vanes which impart vorticities to the incoming air in directions and durations to cause intimate mixing of the fuel and air. This module is readily structurally adaptable for mounting in the air intake system of practically any internal combustion engine.

The invention will be further understood from the drawings and description thereof wherein dimensions and proportions of the structures are not to scale and are not necessarily consistent in the Figures, and wherein:

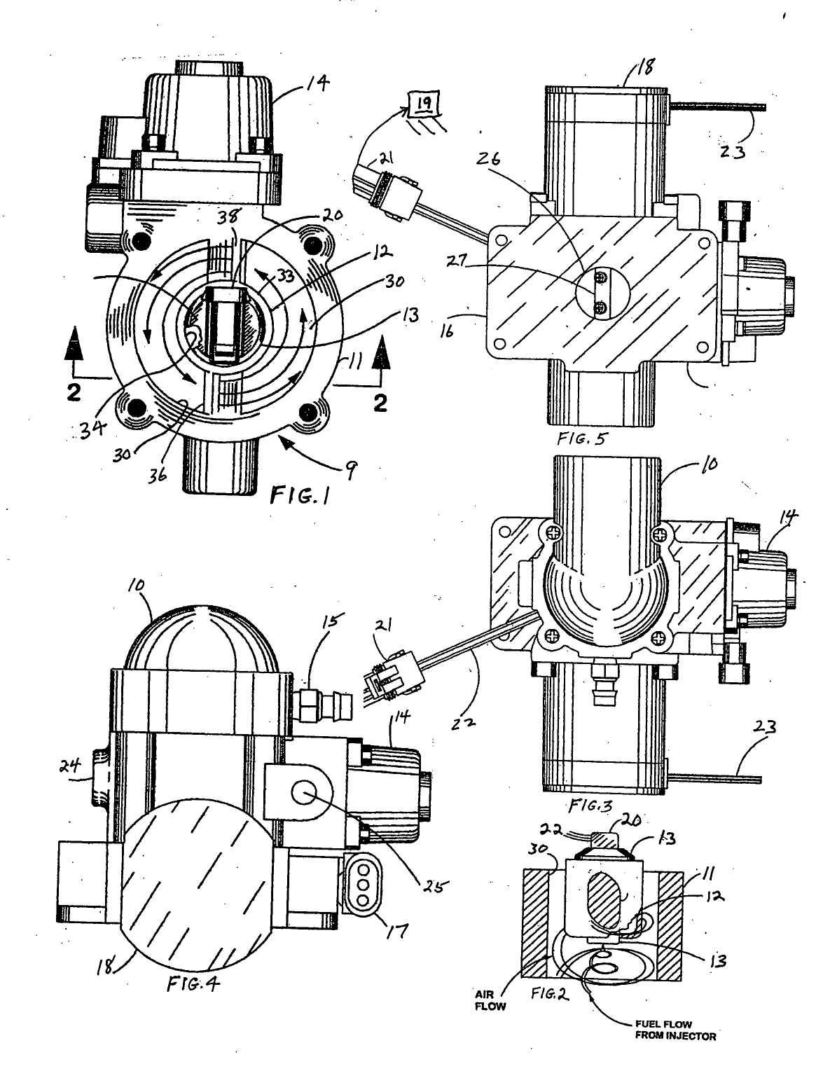

FIG. 1 is a top down view of the fuel injection module with a portion of the fuel injector pod broken away for clarity;

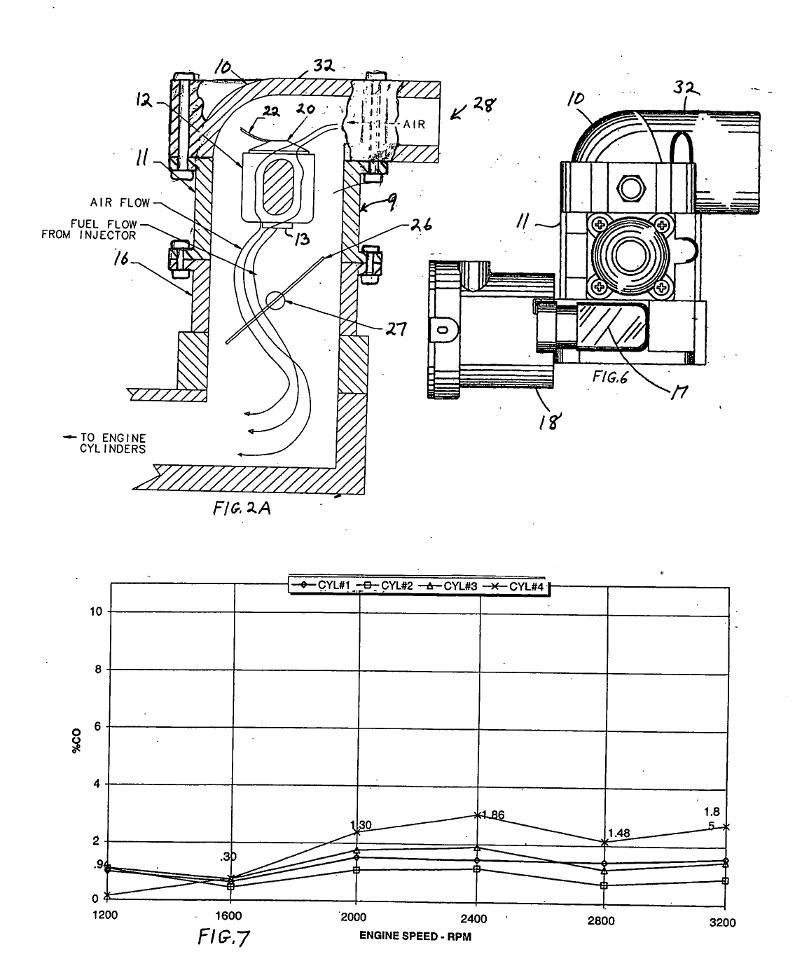

FIG. 2 is a cross-sectional view taken along line 2-2 in FIG. 1;

FIG. 2A is an overall view similar to FIG. 2;

FIG. 3 is a top down view of the three-part assembly of air horn, fuel injection module and throttle body;

FIG. 4 is a view of the assembly of FIG. 3 taken in the direction of line 4-4 in FIG. 3;

FIG. 5 is a view of the assembly of FIG. 3 taken toward the underside of the throttle body;

FIG. 6 is a view of the assembly of FIG. 4 rotated clockwise 90°;

FIG. 7 is a chart of test results of cylinder to cylinder distribution on a 2.5 L engine when the present Fuel Injection Module Housing with vanes is used;

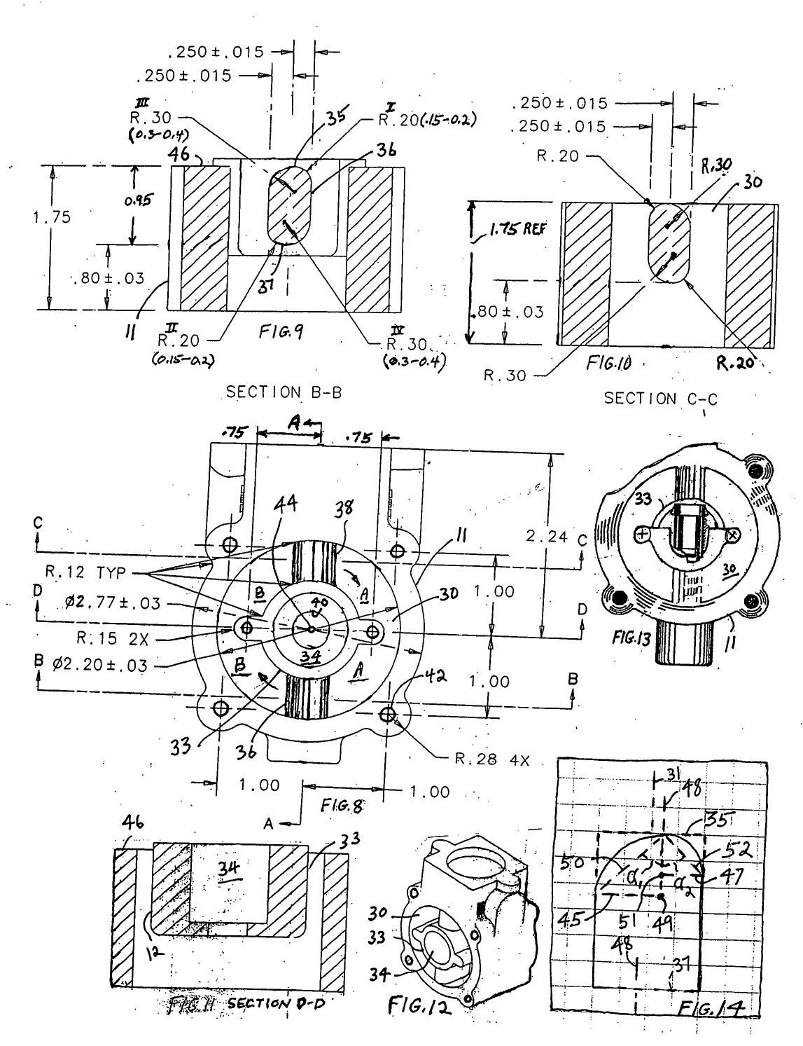

FIG. 8 is a top down view of the present preferred fuel injection module with the fuel injector removed;

FIG. 9 is a cross-sectional view taken along line 9-9 in FIG. 8;

FIG. 10 is a cross-sectional view taken along line 10-10 in FIG. 8;

FIG. 11 is a cross-sectional view taken along line 11-11 in FIG. 8;

FIG. 12 is a perspective view of the module with the fuel injector removed;

FIG. 13 is a top down view as shown in FIG. 1 and showing a screw clamp holding the fuel injector down in the pod; and

FIG. 14 is a greatly enlarged view on graph paper of the vane of FIG. 1 and showing how the radii are defined and measured.

### DESCRIPTION OF THE COMPONENTS

(10) Air Inlet Housing with open circular passage along a flow axis and an open outlet passage connected to said fuel injection module. The said air inlet passage directs the airflow axis to said fuel injection module.

(11) Fuel Injection Module Housing with a plurality of aerodynamic vanes, fuel injector pod with cavity, fuel pressure regulator cavity with said fuel inlet port, fuel return port and a regular vacuum bias port.

(12) Fuel Injection Pod.

(13) Fuel Injector—electronic controlled, mounted in said injector pod, retained by a retaining clip and said injector connected to a fuel source.

(14) Fuel Pressure Regulator connected to said Fuel Injection Module attached by four threaded machine screws.

(15) Air Temperature Sensor—mounted in the air inlet said air inlet housing adapted to the airflow axis.

(16) Throttle Body—with passage regulated by rotating circular throttle plate connected to a throttle shaft where it is inserted at either end through the carrier axis of a bearing, one at each end of said throttle shaft.

(17) MAP (Manifold Absolute Pressure) Sensor—is mounted in said throttle body and adapted to sense the MAP at the air inlet flow axis below said throttle plate.

(18) Governor Assembly—is mounted to said throttle body with said throttle shaft extending into said governor magnet which in turn rotates around a magnetic axis.

(18) Electronic Control Unit (ECU)—is connected to any of a multiplicity of engine or other vehicle components having sensors associated therewith, e.g, said electronic fuel injector, intake air temperature, engine coolant system temperature, MAP or other engine component pressure, governor assembly, and to an electrical power source, and receives and transmits electronic signals for controlling operation of these components or associated structures.

(20) Electrical Connector Socket—connected to wiring harness 10.

(21) Wiring Harness—is connected to said ECU, electronic fuel injector, air temperature sensor, coolant temperature sensor, MAP sensor, governor assembly and electrical source.

(22) Injector Wire Connection—is connected to said ECU via the said Wire Harness.

(23) Governor Wire Connection—is connected to said ECU via the said Wire Harness.

(24) Fuel Inlet—is connected to the main pressurized fuel source.

(25) Fuel Bypass—returns the pressurized fuel to the fuel tank.

(26) Throttle Plate—controls the airflow to the engine.

(27) Throttle Shaft—is connected to the governor and retains the throttle plate and rotates as said throttle plate.

In this structure the throttle body is connected to the fuel injection module with the cross-section or flow area of the fuel-air inlet passage regulated by a horizontally rotating circular throttle plate connected to a throttle shaft which is inserted at either end through the center axis of two bearings, one at each end of the throttle shaft. The throttle shaft is connected to an electronically controlled motor adapted for connection to an electrical source and enclosed in a housing attached to the throttle body. A manifold absolute pressure (MAP) sensor is mounted in the throttle body adapted to sense MAP of the air inlet stream.

The present structure as shown in the drawings is the best mode for carrying out the invention and provides a fuel injection module generally designated 9 adapted to be mounted in the air intake system 28 of an internal combustion engine upstream of a throttle body 16 of the engine. The module comprises an injector housing 11 formed with an air inlet passage 30 which receives air from an inlet horn 32 which typically receives filtered atmospheric air from an air inlet structure (not shown).

A fuel inject pod 12 is mounted generally axially in housing 11 and provides a pocket 34 in which the electromagnetically actuated fuel injector 13 which is electronically connected to a remotely placed electronic control unit (ECU) 19, is stationarily mounted. An aperture 40 is formed thru the bottom of pocket 34 to accommodate the fuel ejection end of the injector. The wall 33 of pocket 34 is affixed to or integrally formed with the housing 11 by two or more aerodynamically configured vanes 36 and 38 which, in cross-section, have the configuration shown in the drawings within no more than small variation in the cross-sectional outline shown, although the overall dimensions of the vanes and also their number can vary in order to accommodate different size engines and intake air flow requirements. As shown in the drawings, the vane radii are reversed from each other in direction to produce maximum vorticity to the air. The aerodynamic shape of the vanes as depicted has been shown to produce the vorticities to the airflow which give the best fuel-air mixing experienced to date.

Various other structures, sensors, fuel and air flow control mechanisms and the like can be employed with the present fuel injection module such as air t sensors, coolant t sensors, fuel P regulators, fuel return systems, and manifold absolute P (MAP) sensors, which can be electrically connected to an (ECU) electronic control unit for regulating air flow, fuel flow, engine speed, and the like.

The present fuel injection module incorporates aerodynamically designed internal vanes that are angled to the receiving airflow. The quantity, size, position and angle of the vanes are determined by the size of the fuel injection module. The size of the fuel injection module is determined by the air and fuel requirement of the specific engine size displacement.

The vane specific angle induces a vorticity to the airflow pattern. The induced vorticity of the airflow controls the turbulence of the air flow in a way that enhances mixing, decreases air drag, reduces engine intake manifold back pressure pulsations, air fuel stand-off and intake manifold boundary layer reversion. The vortex of the airflow is congruent to the angle of the fuel spray pattern of the fuel injector. The vorticity air fuel mixing creates a more homogeneous blend distributed to the engine cylinders creating an improved combustion. In addition, the rotational component of the airflow increases the mixing distance and mixing time for the air and fuel. The enhanced mixing results in reduced exhaust emissions, increased horsepower and reduced fuel consumption.

It is noted that a substantially exact air turning angle “α₁”, of the vanes as shown in the drawings will give the best fuel-air mixing. Straight vanes result in little if any vorticity and turning the angle “α” too greatly results in deposition of the fuel on the throttle body walls with degradation in fuel to air mixing and increased exhaust emissions Referring further to FIGS. 8-11, these figures exemplary ones of in the actual structural dimensions and radii air given in inches for a module employing the present invention. Also given in parenthesis are the preferred ranges for the vane radii. Typically engine operating conditions for this module are as follows:

| | | |
|---|---|---|
| Engine Size | 2.5 | L |
| CFM intake air flow (approximate) | 100 | ft³/min. |
| Engine rpm | 3,000 | |
| Cross-sectional flow area (A & B in FIG. 8) | 2.22 | in² |
| Intake air flow velocity | 5,000 | ft/min. |

Bolt holes 42 are formed thru housing 11 for mounting the module in-line in a carburetion or air intake section as shown in a general way in FIG. 2A. This housing has an air flow axis 44.

It is noted that the thickness of a very satisfactory and tested vane as shown in FIG. 9 is 0.5 in., however this thickness can be enlarged or reduced, e.g., between about 0.3 in., to about 0.75 in., depending on the size of the engine such as between about a 2.0 L to 4.0 L engine wherein there is a spread of intake air flow volumes and flow rates.

Referring to FIG. 9, the ranges of the radii R^{I} the R^{IV} are very effective in creating good—not too much and not too little—intake air swirl for the 2.5 L test engine of FIG. 7. These radii are more clearly defined and measured as shown in FIG. 14 which shows a vane 36 with the top and bottom lines shown dotted to indicate configuration of the vane before being radiused by casting, machining, abrading or the like.

It is noted that line 48 translates to the other side of the longitudinal axis 31 of the vane when the downstream end 37 of the vane is to be radiused such that the radii reverse their lateral positions on end 37. Such downstream end radiusing is preferred but does not require the high degree of accuracy as does the radiusing of upstream end 35 of the vane. In this regard, radiusing the upstream end 35 as shown as well as having perfectly longitudinally oriented vane sides 39 and 40 allows some leeway of, e.g., up to about 0.010 in., or so such as results from casting, machining or the like manufacturing operations.

Main Applications of the Invention:

Forklifts, Aerial Lifts, Power Generators, Baggage Handlers, Wood Chippers, Cranes, Motorized Vehicles, Skip Loaders, Marine Engines, Irrigation Pumps, Air Conditions, Golf Carts, Land Rovers, Street Sweepers, Airport Tractors, Man-Lifts, Motorized Cycles, Farm Tractors, Go Karts and Racing Vehicles.

Test Results:

A fuel system employing the present fuel injection module housing with the present aerodynamic vanes was assembled and tested on a 4 cylinder Nissan H25 engine. The cylinder to cylinder distribution of fuel was measured as a percent of carbon monoxide (CO) level. The higher the CO level, the more fuel there is in the fuel-air mixture. For optimum emissions performance of the engine, it is desired to have the difference in CO levels between cylinders to be as narrow as possible. FIG. 7 shows the results of the test. The largest cylinder to cylinder spread of CO levels is 1.86%, compared to a comparison carburetor where the cylinder to cylinder spread of CO levels is typically 5% or higher. Both the present and the comparison tests employed substantially identical engines, fuel injection devices and acceleration means, with the only relevant difference being the vanes positioned in the fuel injector housing in accordance with the present invention.

Referring to FIG. 7, each percentage valve, e.g., 1.86, represents the difference between the highest CO reading cylinder “*” and the lowest CO reading cylinder “□” shown in the graph.

The invention has been described in detail with particular reference to preferred embodiments thereof, but it will be understood that variations and modifications will be effected with the spirit and scope of the invention.

1. A fuel injection module structurally adapted for mounting in the air intake system of an internal combustion engine, said module comprising
a housing having a wall forming a generally circular air passage therethrough formed around an air flow axis,
a tubular fuel injector pod having a longitudinal dimension is provided in said air passage and is held in a generally axial position therein by air directing vane means having a longitudinal dimension and a lateral dimension and extending longitudinally between and fixed to an outer generally axially oriented surface of said pod and to an inner surface of said wall,
each said vane means having a generally axially oriented centerline and having an upstream surface formed generally laterally with two different radii,
one of said radii being larger than the other to produce a convex upstream surface having an unsymetrical generally lateral curvature whereby air molecules striking said surface will be forced into a swirl pattern between said outer surface of said pod and said inner surface of said wall,
wherein one of said radii ranges from about 0.3-0.4 in., and the other of said radii ranges from about 0.15-0.2 in.

2. The module of claim 1 wherein said radii have their centers on the same longitudinal line and said surface curvature is unsymetrical but continuous.

3. The air intake system of an internal combustion engine having mounted thereinfuel injection module structurally adapted for mounting in the air intake system of an internal combustion engine, said module comprising a housing having a wall forming a generally circular air passage therethrough formed around an air flow axis, a tubular fuel injector pod having a longitudinal dimension is provided in said air passage and is held in a generally axial position therein by air directing vane means having a longitudinal dimension and a lateral dimension and extending longitudinally between and fixed to an outer generally axially oriented surface of said pod and to an inner surface of said wall, each said vane means having a generally axially oriented centerline and having an upstream surface formed generally laterally with two different radii, one of said radii being larger than the other to produce a convex upstream surface having an unsymetrical generally lateral curvature whereby air molecules striking said surface will be forced into a swirl pattern between said outer surface of said pod and said inner surface of said wall, wherein one of said radii ranges from about 0.3-0.4 in., and the other of said radii ranges from about 0.15-0.2 in.

4. The module of claim 3 wherein said radii have their centers on the same longitudinal line and said surface curvature is unsymetrical but continuous.
